(19) United States
(12) Patent Application Publication
(10) Pub. No.: US 2009/0085250 A1
(43) Pub. Date: Apr. 2, 2009

(54) Manufacture of Moulded Paving Elements

(75) Inventor: Peter Astrup Simmelsgaard, Tommerup (DK)

Correspondence Address: BANNER & WITCOFF, LTD., 1100 13th STREET, N.W., SUITE 1200, WASHINGTON, DC, 20005-4051, US

(73) Assignee: Buildmate A/S c/o 3L-Ludvigsen a/s, Vibaekvej 100, Brylle (DE)

(21) Appl. No.: 10/579,554

(22) PCT Filed: Nov. 16, 2004
(86) PCT No.: PCT/EP2004/013050

§ 371 Date: Nov. 10, 2008

(30) Foreign Application Priority Data
Nov. 19, 2003 (GB) 0326947.9

(51) Int. Cl. B28B 1/00

(52) U.S. Cl. 264/294

(57) ABSTRACT

A method for the production of a concrete article having a pattern on a surface thereof, comprising providing a mould having upstanding side walls, and a bottom surface which is patterned with a reverse image of the pattern desired on the surface of the article, introducing into the mould in contact with its patterned surface a first layer of concrete mix by either first introducing a layer of fluid binder slurry in contact with the said surface and applying on top of said slurry layer a layer of aggregate particles, or first introducing a layer of aggregate particles in contact with the said surface and applying on top of said aggregate layer a layer of fluid binder slurry, applying a second layer of concrete mix on top of the first layer, compacting the first and second layers of concrete mix in the mould to form the article in an uncured state, optionally separating the side walls of the mould from the uncured article, and demoulding the article after at least partial curing.

This invention relates to a method of making a moulded concrete article having a pattern on a surface thereof, such as a paving block, slab or tile.

### BACKGROUND TO THE INVENTION

Paving articles such as slabs, blocks and tiles (hereafter called “pavers”) with a distinctive surface finish are commonly cut from a clay mass using a cutting wire or string, then firing in an oven. The firing step is energy intensive and therefore expensive. It would be desirable if concrete could be used instead of clay, since concrete can be cured satisfactorily using less energy than required for firing clay.

However, the distinctive partly smooth, partly roughened surface appearance of a clay paver cut by a cutting wire or string is formed due to the very fine particle structure of clay, which has only very occasional larger particles. The fine particle structure allows the cutter wire to slide smoothly through the clay mass, promoting a smooth surface, while the few larger particles, (0.5-2 mm typically), form a degree of roughness as they are pushed and pulled by the cutter. This principle cannot be used with concrete as concrete mostly consists of small sand particles, often with larger aggregate chips. The wire/string cutting method used for clay blocks, in the case of concrete, creates a very rough uneven surface.

It is known that a desired pattern may be created on the surface of a concrete article by casting the concrete against a patterned surface, for example the base of a mould. It is also known that a membrane of, for example, plastics material, can be applied to the surface of an uncured concrete mass, the mass vibrated, and the membrane peeled off after at least partial curing, thereby creating a smooth surface finish on the cured article.

However, for the production of moulded concrete articles, particularly those which are required to be demoulded before any significant curing, a difficulty arises in transferring a partly smooth pattern to the article from a patterned base of the mould. The difficulty arises because the concrete must be highly fluid in order to flow into good contact with the patterned base. If the concrete mix is sufficiently fluid to achieve this, it will be too fluid to prevent at least partial collapse of the article and/or blurring of the pattern on demoulding before substantial curing. The present invention aims to solve this problem by a stepwise mould filling operation.

### DESCRIPTION OF THE INVENTION

The present invention provides a method for the production of a concrete article having a pattern on a surface thereof, comprising
providing a mould having upstanding side walls, and a bottom surface which is patterned with a reverse image of the pattern desired on the surface of the article,
introducing into the mould in contact with its patterned surface a first layer of concrete mix by either
   (i) first introducing a layer of fluid binder slurry in contact with the said surface and applying on top of said slurry layer a layer of aggregate particles, or
   (ii) first introducing a layer of aggregate particles in contact with the said surface and applying on top of said aggregate layer a layer of fluid binder slurry,
applying a second layer of concrete mix on top of the first layer,
compacting the first and second layers of concrete mix in the mould to form the article in an uncured state,
optionally separating the side walls of the mould from the uncured article, and
demoulding the article after at least partial curing.

As is well known, a concrete mix comprises an aqueous mix of binder particles, usually cement but optionally together with other types of binders such as microfine silica and fly ash, together with aggregate particles such as sand and/or stone chips. Optional components of a concrete mix include surfactants and colourants. As used herein, the term “aggregate particles” refers to the non-binder particles present in a given mix. In particular the term includes sand particles, which may be defined as particles passing through a 4 mm sieve, and/or other larger particles such as stone chips. Natural aggregate materials include quartz, granite, marble, basalt, carborundum, bauxite, and the like, but artificial aggregates and colour-impregnated aggregates are also available

The mould used in the present method has a bottom surface which is patterned with a reverse image of the pattern desired on the surface of the article. The way in which the pattern is created is not critical. For the production of pavers, for example, a cast can be taken of a surface of a model paver (for example a clay paver manufactured in the traditional way described above, or a tool designed to create a desired pattern), using a curable latex or resin, and the resultant latex or resin cast may then be placed in or affixed to the bottom of the mould. Alternatively, the bottom surface of the mould may itself also be made of rubber, epoxy resin or similar, or may be a plate of steel, wood or similar, with the desired pattern formed thereon.

In one application of the method of the invention, the mould is a single mould comprising a patterned bottom surface (or a patterned former placed on the bottom surface of the mould) with upstanding walls defining the periphery of the article. The walls may be integral with the base of the mould or may be detachable to facilitate demoulding the formed article.

However, in a particular embodiment, the mould comprises (a) a patterned bottom surface and a peripheral rim defining the periphery of the article, the height of the rim being sufficient to accommodate the layer of fluid binder slurry and/or the layer of aggregate particles in the cavity formed by the rim and the patterned bottom surface, and (b) side walls, also defining the periphery of the article, which are moveable into and out of engagement with the rim, the height of the side walls being sufficient to accommodate the thickness of the article when the second layer of concrete mix is introduced. In this embodiment the pattern and rim may be formed on a former of rubber or resin material, supported on a flat bottom plate. In the method of the invention as applied to a two-part mould of this kind, (1) the slurry layer, or (2) the aggregate particles layer, or (3) first the slurry layer then the aggregate particles layer, or (4) first the aggregate particles layer then the slurry layer, is/are introduced into the cavity defined by the patterned bottom surface and rim, while the side walls are out of engagement with the rim, and the walls are then brought into engagement with the rim prior to introduction of in case (1) the aggregate particles layer and second layer of concrete mix, in case (2) the slurry layer and second layer of concrete mix, and in cases (3) and (4) the second layer of concrete mix.

In a particular embodiment of the two-part mould method just described, the mould is of one of a contiguous plurality formed on a patterned bottom surface having a plurality of rims defining contiguous cells, the rim of each cell defining the periphery of an article, and a side wall tool moveable into and out of engagement with the rims to form the plurality of moulds when engaged with the rims.

Whether the mould is an integral or two-part mould, the first step in filling the mould can be performed in two ways:
One way is to introduce of a layer of fluid, binder slurry in contact with the patterned bottom surface and applying on top of the slurry layer a layer of aggregate particles. The term “fluid” in this in this embodiment refers to the requirement that when introduced into the mould the slurry should spread and flow freely into contact with the contours of its patterned surface if necessary with the aid of vibration. The term “binder slurry” refers to an aqueous composition comprising at least binder particles, for example principally cement particles, and optionally some aggregate particles.
In the other way, a layer of aggregate particles is introduced in contact with the said surface and a layer of fluid binder slurry is applied on top of the aggregate layer. The term “fluid” in this in this embodiment refers to the requirement that when introduced on top of the aggregate layer, the slurry should spread and flow freely over the aggregate layer and encapsulating the aggregate particles. The term “binder slurry” in this embodiment again refers to an aqueous composition comprising at least binder particles, for example principally cement particles, and optionally some aggregate particles.

In the two-part mould embodiment, the cavity formed by the rim and patterned bottom surface before engaging the side walls may be filled with slurry layer alone, aggregate particles layer alone, or both the slurry and aggregate particles layers (or vice versa) and the second layer of concrete mix may then be introduced after engagement of the side walls and rim. Also in the two-part mould embodiment the contents of the cavity(ies) defined by the patterned bottom surface and the rim(s) may leveled by drawing a scraping tool over the rim(s) in a direction generally parallel to the patterned bottom surface to remove contents which overfill the cavity(ies), prior to engaging the side walls to complete the mould formation and filling the remaining contents.

Irrespective of the way selected for forming the slurry and aggregate layers, their thicknesses are not critical. The thickness of the slurry layer will normally be in the range, for example, 1 to 20 mm. and that of the aggregate layer will normally be similar.

In forming the first layer of concrete mix in two stages, from slurry and aggregate layers, the intention is that the fluidity of the slurry layer will facilitate faithful reproduction of the mould pattern, and that the slurry and aggregate layers will intermix, thereby stabilising the resultant first concrete layer mix, rendering it less fluid than the slurry, so that it is essentially self-supporting on demoulding.

In one embodiment of the method of the invention, the aggregate layer contains no binder particles. In another embodiment, the aggregate layer is applied as a concrete mix containing a higher weight ratio of aggregate particles:binder and/or aggregate particles:water than the slurry layer. The population of aggregate particles present in the first layer of concrete mix may be selected so that it differs from that of the second layer of concrete mix in respect of (a) binder:aggregate particles weight ratio and/or (b) aggregate particles size distribution and/or (c) material constituting the aggregate particles. In this way, the composition of the first layer of concrete mix can be selected to exhibit, when the article is cured, properties different from that of the second concrete mix, resulting in an article whose patterned surface is, for example harder wearing or more weather resistant than the bulk of the article. Alternatively, the composition of the first layer of concrete mix formed from the slurry and aggregate layers may be selected to match that of the second layer of concrete mix.

The next step is to apply the second layer of concrete mix on top of the first (formed from the slurry and aggregate layers). This second layer will normally form the bulk of the article and its composition and thickness will be selected according to the bulk properties required of the finished article.

Prior to demoulding, the two concrete mix layers are compacted, for example in a press, Compaction can squeeze excess water from the contents of the mould, and improve the stability of the mass if demoulded or partly demoulded when insufficiently cured. In one embodiment of the invention the slurry and aggregate layers are compacted in the mould prior to application of the third layer. This can be helpful in promoting intermixing, improving the stabilisation of the slurry layer as discussed above. In another embodiment, all three layers are compacted after the mould is filled.

Compaction and intermixing of the layers in the mould may be assisted either indirectly by vibration of the mould and/or directly by application of a vibrator head to the contents of the mould. A vibration step may be employed before, during or after a compaction step as described above. In particular, a vibration step may be applied to the slurry and aggregate layers before and/or during compaction, and prior to introduction of the second layer of concrete mix.

In another embodiment of the method of the invention the first layer of concrete mix, formed from the slurry and aggregate layers, may be partially cured prior to introduction of the second layer of concrete mix.

The final step in the method of the invention is demoulding of the article, with the pattern formed on its lower surface as a result of contact with the patterned bottom surface of the mould, after at least partial curing. In the embodiment of the method of the invention which uses a mould with detachable side walls, or a two-part mould as described above, having side walls which engage and disengage rims formed on the bottom plate, the side walls of the mould may be detached, or disengaged from the said rim(s), after the second layer of concrete mix is applied, and the article(s) may be at least partially cured while remaining in contact with the patterned bottom surface of the mould prior to separation therefrom. It will often be convenient to leave the article(s) in place on the patterned bottom surface of the mould while they cure, or transport them thereon to a curing oven for curing, before finally completing the demoulding by separation of the article(s) from the bottom surface of the mould.

The method of the invention is particularly useful for the manufacture of concrete pavers, for example paving slabs, blocks or tiles, which mimic the surface effect of clay pavers produced by wire or string cutters.

The object of the invention, namely the provision of a concrete article having a pattern on a surface thereof, is also achieved by a method comprising providing a preformed, self-supporting clay or cementitious article having a patterned surface and an opposed backing surface, casting a concrete mix against said opposing surface, or pressing said opposing surface against a concrete mix, and curing the concrete mix to form a laminate of the preformed article and the cured concrete mix.

In this embodiment of the invention, the preformed article may be a thin plate, for example in the range 5 to 50 mm thick, of clay or of cured concrete containing small aggregate particles in the form of a sand. The manner in which the plate is formed is not critical. For example, a clay article may be cut from a clay mass and/or moulded into the desired form, and a cementitious article may be prepared in a similar manner to that described above, by casting a fluid mix of binder and aggregate onto a patterned bottom surface of a mould, optionally with pressing and/or vibration, and the resultant uncured or partially cured plate may then be demoulded and, if not already self supporting, may be further cured until self-supporting. The pattern may also be formed on the plain surface of a partially cured but still plastic article by impressing with a pattern tool, optionally with vibration to ensure good contact between the tool and the article.

For casting a concrete mix against the preformed article, the article may be placed with its patterned face down in a walled former, or in the base of a mould, and the concrete mix introduced in contact with the upwardly facing opposed surface, again with optional pressing and vibration, prior to demoulding the resultant laminate. Alternatively, the preformed article may be pressed onto the surface of a concrete mix in a mould, and the resultant laminate may then be demoulded when sufficiently self supporting.

To aid bonding between the preformed article and the cast concrete backing, the opposed surface of the article may be roughened during fabrication of the article, or keying elements such as aggregate chips may be partially embedded in the opposed surface during such fabrication.

1. A method for the production of a concrete article having a pattern on a surface thereof, comprising
providing a mould having upstanding side walls, and a bottom surface which is patterned with a reverse image of the pattern desired on the surface of the article,
introducing into the mould in contact with its patterned surface a first layer of concrete mix by either
(i) first introducing a layer of fluid binder slurry in contact with the said surface and applying on top of said slurry layer a layer of aggregate particles, or
(ii) first introducing a layer of aggregate particles in contact with the said surface and applying on top of said aggregate layer a layer of fluid binder slurry,
applying a second layer of concrete mix on top of the first layer,
compacting the first and second layers of concrete mix in the mould to form the article in an uncured state,
optionally separating the side walls of the mould from the uncured article, and
demoulding the article after at least partial curing.

2. A method as claimed in claim 1 wherein
the mould comprises (a) a patterned bottom surface and a peripheral rim defining the periphery of the article, the height of the rim being sufficient to accommodate the layer of fluid binder slurry and/or the layer of aggregate particles in the cavity formed by the rim and the patterned bottom surface, and
(b) side walls, also defining the periphery of the article, which are moveable into and out of engagement with the rim, the height of the side walls being sufficient to accommodate the thickness of the article when the second layer of concrete mix is introduced, and wherein: (1) the slurry layer, or (2) the aggregate particles layer, or (3) first the slurry layer then the aggregate particles layer, or (4) first the aggregate particles layer then the slurry layer, is/are introduced into the cavity defined by the patterned bottom surface and rim, while the side walls are out of engagement with the rim, and the walls are then brought into engagement with the rim prior to introduction of in case (1) the aggregate particles layer and second layer of concrete mix, in case (2) the slurry layer and second layer of concrete mix, and in cases (3) and (4) the second layer of concrete mix.

3. A method as claimed in claim 2 wherein the mould is of one of a contiguous plurality formed on a patterned bottom surface having a plurality of rims defining contiguous cells, the rim of each cell defining the periphery of an article, and a side wall tool moveable into and out of engagement with the rims to form the plurality of moulds when engaged with the rims.

4. A method as claimed in claim 2 wherein the contents of the cavity(ies) defined by the patterned bottom surface and the rim(s) are leveled by drawing a scraping tool over the rim(s) in a direction generally parallel to the patterned bottom surface to remove contents which overfill the cavity(ies).

5. A method as claimed in claim 2 wherein the side walls of the mould are disengaged from the said rim(s) after the second layer of concrete mix is applied, and the article(s) is/are at least partially cured while remaining in contact with the patterned bottom surface of the mould prior to separation therefrom.

6. A method as claimed in claim 1 wherein the aggregate layer contains no binder particles.

7. A method as claimed in claim 1 wherein the aggregate layer is applied as a concrete mix containing a higher weight ratio of aggregate particles:binder, aggregate particles:water than the slurry layer, or both.

8. A method as claimed in claim 1 which includes compaction of the slurry and aggregate layers prior to application of the second layer of concrete mix, compaction of the article in the mould prior to its separation from the mould, or both.

9. A method as claimed in claim 1 which includes vibration of the slurry, aggregate layers, or both prior to application of the third layer, vibration of the article in the mould prior to its separation from the mould, or both.

10. A method as claimed in claim 1 wherein the first layer of concrete mix formed from the slurry and aggregate layers is partially cured prior to application of the second layer of concrete mix.

11. A method as claimed in claim 1 wherein the population of aggregate particles present in the first layer of concrete mix differs from that of the second layer of concrete mix in (a) binder:aggregate particles weight ratio, (b) aggregate particles size distribution, (c) material constituting the aggregate particles, or combinations thereof.

12. A method as claimed in claim 1 wherein the composition of the first layer of concrete mix formed from the slurry and aggregate layers matches that of the second layer of concrete mix.

13. A method as claimed in claim 1 wherein the article is a paver, the pattern being formed on its intended upper surface.

14. A method for the production of an article having a pattern on a surface thereof, comprising providing a preformed, self-supporting clay or cementitious article having a patterned surface and an opposed backing surface, casting a concrete mix against said opposing surface, or pressing the opposing surface against a concrete mix, and curing the concrete mix to form a laminate of the preformed article and the cured concrete mix.

15. A method as claimed in claim 14 wherein the preformed article is a plate of cured concrete containing aggregate particles in the form of a sand.

16. A method as claimed in claim 15 wherein the plate is formed by casting a fluid mix of binder and aggregate onto a patterned bottom surface of a mould, optionally with pressing vibration, or both, separating the resultant uncured or partially cured plate from the patterned bottom surface, and, if not already self supporting, further cured the article until self-supporting.

17. A method as claimed in claim 13 wherein the opposed surface of the preformed article is roughened or provided with partially embedded keying elements.
